(19) United States
(12) Patent Application Publication
(10) Pub. No.: US 2005/0063257 A1
(43) Pub. Date: Mar. 24, 2005

(54) Audio bookmark

(76) Inventor: David G. Clark, Frederick, MD (US)

Correspondence Address: WELSH & KATZ, LTD, 120 S RIVERSIDE PLAZA, 22ND FLOOR, CHICAGO, IL, 60606, US

(21) Appl. No.: 10/669,912

(22) Filed: Sep. 24, 2003

(51) Int. Cl. G11B 7/085

(52) U.S. Cl. 369/30.26

(57) ABSTRACT

An inexpensive audio bookmark system is provided that includes a control interface in the form of an electrical plug/receptacle type adaptor for plugging into an electrical power source receptacle. The adaptor includes female receptacles for receiving a power plug from an audio or audio-visual device in the form of a tape or video cassette player. The adaptor is connected in series with a remote control push-button switch having a low pressure responsive push button actuator normally biased to an open-circuit position interrupting power to the tape player. When playing a books-on-tape recording or the like, the listener manually depresses the remote switch push button actuator to energize the audio device. In the event the listener is distracted or dozes so as to release the push button actuator, the audio device will stop playing, thereby maintaining the tape deactivated at substantially the precise point at which the listener has been distracted or dozes off. Thereafter, subsequent depressing of the remote control switch push button initiates play at substantially the point at which play was interrupted.

### FIELD OF INVENTION

The present invention relates generally to audio and audio-visual devices, such as audio tape cassette players, and more particularly to a system for deactivating the playing of an audio or audio-visual recording when a listener is distracted or dozes off so that re-activation of the player occurs at substantially the same point on the recording where deactivation occurred.

### BACKGROUND OF THE INVENTION

Books and other printed materials have long been the primary means of publishing novels and non-fictional works of authors. Books and other printed publications are available in a variety of forms to both educate and entertain. One drawback in the reliance on printed publications is the obvious requirement that one have the ability to read. For example, many elderly persons suffer from a variety of visual problems, such as cataracts, macular degeneration, etc. that significantly reduce or eliminate their ability to read. Physiological problems, such as dyslexia, may also impair the ability of afflicted persons of all ages to readily read a book or other printed material.

In addressing the aforedescribed reading limitations, many libraries now provide audio recordings of books and other written materials, generally termed books on tape. The availability of books on tape enables one to listen to a recorded version of a novel or the like, such as while undertaking another activity or because of difficulty in reading. Books on tape have significantly assisted visually impaired people to enjoy writings that would otherwise not be available to them.

While books on tape have enjoyed relatively wide success, they present at least one problem when played by a tape cassette player. For example, if a person listening to a book on tape is distracted, as by a telephone call or a doorbell, or is relaxing and dozes while listening to a tape, the tape will continue to run or advance until it reaches the end of the tape at which time the tape or cassette player may automatically shut off or may rewind itself to its starting point before turning to an off mode. When the person awakes, or is no longer distracted, and wants to continue listening to the tape, it frequently is difficult, if not impossible, to quickly determine the point on the tape where the listener was distracted or dozed off. This often leads to frustration and to a lessening of any enjoyment the person would otherwise have derived from listening to the tape. A need thus exists for a relatively simple and inexpensive system and method for identifying the precise location on an audio or audio-visual tape recording where the listener was distracted, whereby an audio bookmark is established that enables subsequent listening beginning at substantially the precise tape location where interruption occurred.

### SUMMARY OF THE INVENTION

In carrying out the present invention, an inexpensive audio bookmark system is provided that includes a control interface in the form of an electrical plug type adaptor adapted to be plugged into a conventional 110 volt home or commercial electrical power source receptacle. The adaptor includes a pair of internal electrical power (positive) and ground (negative) conductors connected between conductor prongs on the adaptor and corresponding female receptacles formed in an end of the adaptor opposite the male prongs. Preferably the power conductor internally of the plug-in adaptor is connected in circuit with a remote control push-button switch having a low pressure actuated push button actuator normally biased to an open-circuit position interrupting current through the power conductor in the adaptor. A audio-visual cassette or tape player is electrically connected to the female receptacle end of the adaptor so that the player is only connected in circuit with the power source when the remote control switch push button actuator is activated to close the circuit. Thus, when playing a books-on-tape cassette, the listener depresses the remote switch push button actuator to energize the tape player. In the event the listener is distracted or dozes so as to release the push button actuator, the cassette or tape player will stop, thereby maintaining the tape deactivated at substantially the precise point at which the listener was distracted or dozes off. When the listener wishes to resume listening to the recorded book on tape, the remote switch push button actuator is again activated by depressing it to initiate play at substantially the same point at which play was interrupted. In this manner, the sense of the story is promptly recalled without the frustration of having to recall and search for the precise point in the book-on-tape story at which interruption occurred.

Accordingly, one of the primary objects of the present invention is to provide a relatively inexpensive audio bookmark system for precise marking of an audio/visual recording, such as a book-on-tape, by stopping play of an audio tape player when the listener is distracted or dozes while listening to the book-on-tape.

A more particular object of the present invention is to provide an audio bookmark system and method that employ a control interface in the form of an adaptor operative to interconnect a tape cassette player to a power source, and wherein a push-button actuator switch is operatively associated with the adaptor and includes normally open switch contacts responsive to light pressure depression of the push button to close a power circuit to the tape player, whereby distraction of or dozing by the listener normally causes the push button actuator to be released and remotely stops the tape player at a precise position enabling play to continue at the precise stop position upon subsequent activation of the actuator switch.

Further objects, features and advantages of the audio bookmark in accordance with the present invention will become apparent from the following detailed description when taken in conjunction with the accompanying drawing wherein like reference numerals designate like elements throughout the several views.

### BRIEF DESCRIPTION OF THE DRAWINGS

FIG. 1 is a schematic block diagram of an audio-visual tape player control system in accordance with the present invention for establishing a precise location on a tape recording at which play is temporarily interrupted as by the listener being distracted or dozing off while listening to the tape recording; and

FIG. 2 schematically illustrates the various components of the system shown in the block diagram of FIG. 1.

While the present invention is susceptible of various modifications and alternative forms, specific embodiments thereof are shown by way of example in the drawings and will herein be described in detail. It should be understood, however, that the drawings and detailed description thereof are not intended to limit the invention to the particular form disclosed, but on the contrary, the invention is intended to cover all modifications, equivalents and alternatives falling within the spirit and scope of the invention.

### DETAILED DESCRIPTION

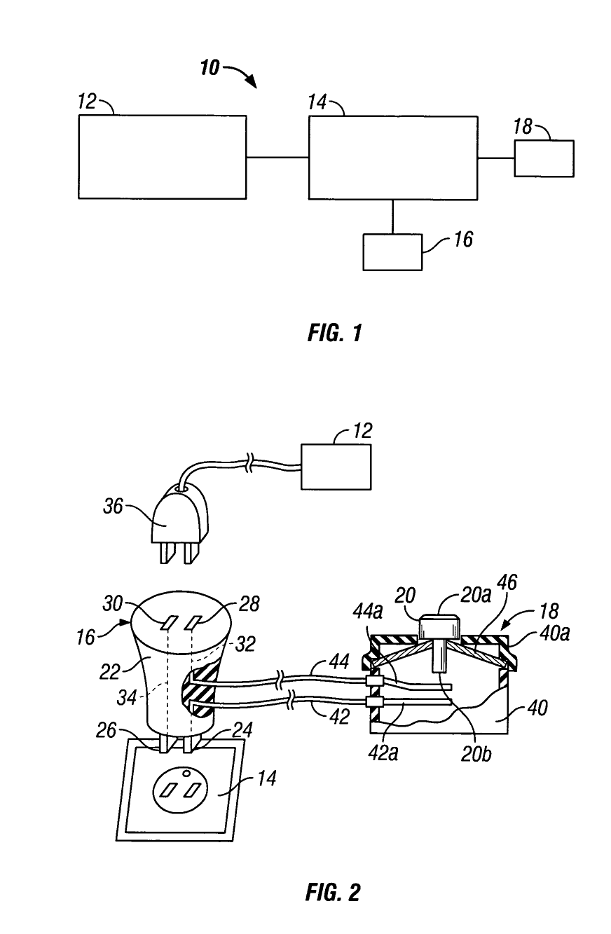

Referring now to the drawing, and in particular to FIG. 1, a system for controlling an audio-visual device in the form of an audio or audio-visual cassette tape or disc type player or the like so as to establish a relatively precise location on a tape or disc when play is interrupted before completion, termed an audio bookmark, is indicated generally at 10. The control system 10 enables subsequent tape or disc playing to begin at substantially the precise point of interruption. In the schematic diagram of FIG. 1, the audio bookmark system includes a sound or sound/visual reproduction device such as an audio cassette tape player or audio-visual cassette or disc player indicated schematically at 12. The sound reproduction device or cassette tape player 12 is adapted to be selectively connected to an electrical power source, such as a conventional 110 volt ac household or commercial plug-in power outlet receptacle 14, through a plug-in power adaptor 16. Connection of the cassette tape player 12 to the power source 14 through the adaptor 16 is under the control of a push-button switch 18 which may alternatively be termed a use sensor. The plug-in power adaptor 16 is operative to selectively interconnect the cassette tape player or audio/visual device 12 to the power outlet receptacle 14 so as to control operation of the tape cassette player or audio-visual device in response to manual actuation of a push button 20 on the push-button switch or use sensor 18.

Turning now to a more detailed description of the audio bookmark system 10, and referring particularly to FIG. 2, the audio-visual device 12 may take the form a cassette tape player recorder for playing books on tape as particularly enjoyed by persons who are visually impaired and have difficulty reading written materials, such as some elderly persons and those who suffer a physiological impairment such as dyslexia so that reading is sometimes difficult or very time consuming. Alternatively, the audio-visual device 12 may comprise an audio-visual video cassette or disc type player. By utilizing the cassette tape player 12 in conjunction with the audio bookmark system 10 of the present invention, if listening to a tape or video recording is interrupted, such as by the listener being distracted by a telephone call or doorbell or the like, or dozing off while listening to the tape, the recorder will stop playing responsive to release of the push button 20 of push-button switch 18. In such event, a listener may subsequently re-activate the cassette tape player at precisely the point at which the deactivation or interruption occurred by again manually depressing the push button 20 to close the switch contacts 42a and 44a. In this manner, the sense of the story can be promptly recalled by the listener without the frustration of having to recall and search for the precise point in the book-on-tape story at which interruption occurred.

As illustrated schematically in FIG. 2, the plug-in power adaptor 16, which may be termed a control interface, comprises an electrical plug-in type adaptor having an electrically non-conductive housing 22 of generally rectangular or circular transverse cross section. The adaptor housing may be made of a suitable plastic and supports a pair of conventional male plug-in conductive prongs 24 and 26 at one end. The conductive prongs 24, 26 are in turn electrically connected, respectively, to corresponding electrically conductive female socket type receptacles 28 and 30 disposed at the opposite end of the housing 22, either directly or by being hard wired through a pair of internal power (hot) and ground conductors 32 and 34, respectively.

The internal power conductor 32 in the plug-in adaptor 16 is preferably electrically connected in series with the push-button switch 18 through a pair of elongated flexible insulated conductor wires 42 and 44 so as to enable selective remote connection of the audio-visual device or cassette tape player 12 to the power source receptacle 14 when an electrical plug 36 on the cassette player is plugged into receptacle slots 28 and 30 in the adaptor. The push-button switch 20 may take different forms that enable activation by applying a light force to an actuator push button. In the illustrated embodiment, the remote control push-button switch 18 includes an electrically nonconductive housing 40 that may also be made of a suitable plastic and houses a pair of electrical contacts 42a and 44a connected, respectively, through the conductors 42 and 44 to the internal conductor 32 in the adaptor 22. The conductive switch contact 42a is relatively fixed within the housing 40 while the contact 44a comprises a movable resilient spring contact normally spaced from contact 42a. The non-conductive push button 20 is suitably sized and supported by the housing 40 so that a finger or thumb contact surface 20a on a cylindrical head portion of the push button is exposed outwardly of housing 40, and an actuator or contact end 20b of the push button is operative to engage the spring contact 44a and close the contacts 42a and 44a when the push button is depressed.

The push button 20 is mutually cooperable with spring means for urging the push button to its outer non-actuated position as shown in FIG. 2. In the illustrated embodiment, the spring means comprises an annular beveled or normally conical shaped spring member 46, such as a beveled washer type annular spring, to which the contact end 20b of the push button is affixed, as by a friction fit. The spring member 46 is selected so that it normally biases the push-button to an outer position relative to the housing 40 but can be depressed by light pressure applied to the exposed end 20a to close the contacts 42a and 44a. Release of the push button 20 causes it to be returned to its outer position by the annular spring 46 to thereby open the contacts 42a and 44a. It will be understood that the spring means may comprise any suitable conventional spring preferably disposed within housing 40 and cooperative with the push button 20 to bias it to its outward position. The conductor wires 42 and 44 are of sufficient length, preferably about at least 15 feet is length, to enable control of the audio-visual device 12 from a remote location, that is, from beyond a range of direct manual contact with the audio-visual device by the listener.

Thus, in accordance with the present invention, a relatively inexpensive system is provided for remotely controlling play of a cassette tape player or audio-visual video cassette player so that play is controlled by the listener manually actuating a light-pressure pressure actuated switch button. Release of the switch button terminates play as when the listener is interrupted or dozes so as to release the switch button. Subsequent activation of the remote switch-button switch re-activates the tape or video player at precisely the point at which play was previously terminated.

While a preferred embodiment of the invention has been illustrated and described, it will be understood that changes and modifications may be made therein without departing from the invention in its broader aspects. Various features of the invention are defined in the following claims.

1. Apparatus for controlling an electrically powered audio device operative to play a sound recording, such apparatus comprising, in combination:
a control interface adapted to interconnect the audio device to a power source so as to control operation of the audio device; and
a push-button switch remotely coupled to the control interface, the control interface and push-button switch being mutually cooperable to require continuous activation of a push button on the switch by a user to connect the audio device to the power source.

2. The apparatus for controlling an audio device as defined in claim 1 wherein the control interface comprises a pause control interface.

3. The apparatus for controlling an audio device as defined in claim 2 wherein the control interface includes a power input connection for supplying power to the audio device.

4. The apparatus for controlling a audio device as defined in claim 3 wherein the power input connection comprises a power supply cord.

5. The apparatus for controlling an audio device as defined in claim 4 further including a plug/receptacle assembly adapted for connection in series between a power source and the power supply cord, said push-button switch including a set of electrical contacts connected in series with a conductor of the plug/receptacle assembly.

6. The apparatus for controlling an audio device as defined in claim 5 wherein the plug/receptacle assembly includes a male plug and a female receptacle.

7. The apparatus for controlling an audio device as defined in claim 5 further comprising a power cord connecting the plug/receptacle assembly to the push-button switch so as to enable remote control of the plug/receptacle assembly.

8. The apparatus for controlling an audio device as defined in claim 1 wherein the push-button switch comprises a momentary contact switch responsive to light pressure activation of the push button.

9. The apparatus for controlling an audio device as defined in claim 1 wherein the audio device comprises a tape player.

10. The apparatus for controlling an audio device as defined in claim 1 wherein the audio device comprises a compact disk player.

11. The apparatus for controlling an audio device as in claim 1 wherein the audio device comprises an optical disk player.

12. The apparatus for controlling an audio device as defined in claim 1 wherein the audio device comprises an audio-visual video disk player.

13. An apparatus for activating an electrically powered audio device, such apparatus comprising:
a power supply cord for supplying power to the audio device;
a plug/receptacle assembly adapted for connection in series between a power source and the power supply cord; and
a push-button switch disposed in series with a conductor of the plug/receptacle assembly, the push-button switch including a set of electrical contacts responsive to continuous manual activation of a push button by a user to activate the audio device.

14. The apparatus for controlling an audio device as defined in claim 13 wherein said set of electrical contacts of the push-button switch are connected in series with said conductor of the plug/receptacle assembly.

15. The apparatus for controlling an audio device as defined in claim 14 including a power cord connecting the plug/receptacle assembly to the push-button switch.

16. The apparatus for controlling an audio device as defined in claim 13 wherein the push-button switch comprises a momentary contact switch.

17. The apparatus for controlling an audio device as defined in claim 13 wherein the audio device comprises a tape player.

18. The apparatus for controlling an audio device as defined in claim 13 wherein the audio device comprises a compact disk player.

19. The apparatus for controlling an audio device as defined in claim 13 wherein the audio device comprises an optical disk player.

20. The apparatus for controlling an audio device as defined in claim 13 wherein the audio device comprises a video disk player.

21. A method for marking an audio or audio-visual recording at a point where play is interrupted while being played on an audio device powered from an electrical power outlet, said method comprising the steps of:
(a) interconnecting the audio device to the electrical power outlet through a control interface selectively operable to control operation of the audio device; and
(b) coupling a push-button switch to the control interface so as to enable control of the audio device remotely from the control interface in response to activation of a push button on the switch such that deactivation of the push button causes the audio device to stop play, and re-activation of the push button switch initiates continued play from the point of interruption of play.
